(19) United States
(12) Patent Application Publication
(10) Pub. No.: US 2016/0023543 A1
(43) Pub. Date: Jan. 28, 2016

(54) INFLATABLE DOOR SYSTEM, KIT FOR INFLATABLE DOOR SYSTEM

(71) Applicant: Mark A. RUTLAND, Jacksonville, FL (US)

(72) Inventor: Mark A. RUTLAND, Jacksonville, FL (US)

(21) Appl. No.: 14/722,697

(22) Filed: May 27, 2015

Related U.S. Application Data
(60) Provisional application No. 62/003,966, filed on May 28, 2014.

(51) Int. Cl. B60J 5/04; B60J 11/06

(52) U.S. Cl. CPC B60J 5/0487; B60J 11/06

(57) ABSTRACT

An inflatable door for a vehicle and an inflatable door kit for a vehicle. The inflatable door includes a frameless bladder; at least one pin coupled to the frameless bladder; and at least one connection element coupled to a frame of the vehicle to receive the at least one pin.

### CROSS-REFERENCE TO RELATED APPLICATIONS

The instant application claims the benefit of U.S. Provisional Application No. 62/003,966 filed May 28, 2014, the disclosure of which is expressly incorporated by reference herein its entirety. Further, this application is related to U.S. application Ser. No. 14/357,128, which is a U.S. National Stage of International Application No. PCT/US2013/027352 filed Feb. 22, 2013 claiming the benefit to U.S. Provisional Application No. 61/602,299 filed Feb. 23, 2012, the disclosures of which are expressly incorporated by reference herein in their entireties.

### BACKGROUND OF THE EMBODIMENTS

1. Field of the Invention

Embodiments of the invention are directed to removably attachable doors for an open vehicle, such as a golf cart, all-terrain vehicle (ATV), utility vehicle, cart, etc.

2. Discussion of Background Information

U.S. Pat. No. 4,621,859 to SPICHER is directed to a method of attaching a weathershield to a vehicle. The weathershield is designed as a shroud to cover the front and rear portions of the vehicle, with openings on the sides to receive doors. The doors are affixed to the frame of the vehicle via hinges having a removable pin. The disclosure of this document is expressly incorporated by reference herein in its entirety.

U.S. Pat. No. 5,393,118 to WELBORN is directed to a framed enclosure for vehicles. Doors, formed by plastic sheet over a tubular frame, are affixed to the vehicle. For changing weather conditions, a zipper is arranged at the top of the door so that the plastic sheet at the top of the frame can be separated from the frame in order to partially open the enclosure. The disclosure of this document is expressly incorporated by reference herein in its entirety.

U.S. Pat. No. 6,776,445 to CONNOR et al. is directed to a vehicle cover attached to the vehicle's frame. The cover includes at least one removable framed door. The disclosure of this document is expressly incorporated by reference herein in its entirety.

### SUMMARY OF THE EMBODIMENTS

Embodiments are directed to an inflatable door for a vehicle. The inflatable door includes a frameless bladder; at least one pin coupled to the frameless bladder; and at least one connection element coupled to a frame of the vehicle to receive the at least one pin.

According to embodiments, the inflatable door can further include a plastic window. The plastic window may be one of removeable and openable.

In accordance with embodiments of the invention, the frameless bladder may include two body pieces. The frameless bladder can further include at least one of baffles and ribs.

In embodiments, the at least one pin can be connectable to the at least one connection element to form a hinge. The at least one connection element can include a channel structured and arranged to receive and retain the at least one pin. Further, the frameless bladder may have a bearing edge and the at least one pin can be arranged along and parallel to the bearing edge. The bearing edge can include one of a retaining tape or flap and the at least one pin may include one of a polygonal and an oval loop arranged so that the one of the retaining tape or flap can hold and retain the loop along and parallel to the bearing edge.

According to still other embodiments, the inflatable door can further include a strap to hold the door in a closed position.

In accordance with further embodiments, the inflatable door can include a nipple for inflating the frameless bladder.

According to still further embodiments, the inflatable door may include a quick release valve for deflating the frameless bladder.

Embodiments are directed to an inflatable door kit for a vehicle. The inflatable door kit includes a frameless bladder; at least one pin coupled to the frameless bladder; and at least one connection element removably attachable to a frame of the vehicle to receive the at least one pin.

According to embodiments, the inflatable door kit can include a side panel removably attachable to the frame of the vehicle adjacent the frameless bladder. The frameless bladder and the side panel can include windows. Further, the frameless bladder and the side panel are inflatable. The at least one connection element can be connected to the frame of the vehicle via a clamping coupling. The at least one bladder may include at least one of ribs and baffles arranged at least below the window. Moreover, the frameless bladder can have a bearing edge and the at least one pin may be arranged along and parallel to the bearing edge, and the side panel may have at least two loops located at a top edge that are structured and arranged for connection to the vehicle.

In accordance with still yet other embodiments of the present invention, the frameless bladder can include two body pieces joined together in an air-tight manner.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates an embodiment of a frameless vehicle door for a vehicle door kit;

FIG. 2 illustrates an alternate embodiment of a frameless vehicle door with a frameless side panel for a vehicle door kit;

FIG. 3 illustrates an alternate embodiment of a frameless vehicle door for a vehicle door kit;

FIG. 4 illustrates an alternative connector for connecting the vehicle door to the frame;

FIG. 5 illustrates an alternative connector for connecting the vehicle door to the frame; and

FIG. 6 shows an alternative embodiment of the vehicle door and side panel.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

According to embodiments of the invention, the vehicle doors are designed to:
Produce a removable light weight door;
Allow storage of the doors under the canopy of the cart;
Avoid the need for zippers for ingress to or egress from the cart and/or for providing fresh air after inclement weather has ended; and
Provide a simple yet be cost effective design.

Moreover, it is contemplated that the doors can be manufactured and sold in completed form with hardware for attaching the doors to a vehicle. It is understood that, as the dimensions of vehicle vary from manufacturer to manufacturer, the dimensions of the manufactured doors would likewise vary depending upon which manufacturer's vehicle the door was to be removably attached. Manufacturers for whose vehicles doors can be provided in accordance with embodiments of the invention include, but are not limited to, EZ-GO, Club Car, Yamaha, John Deere, etc.

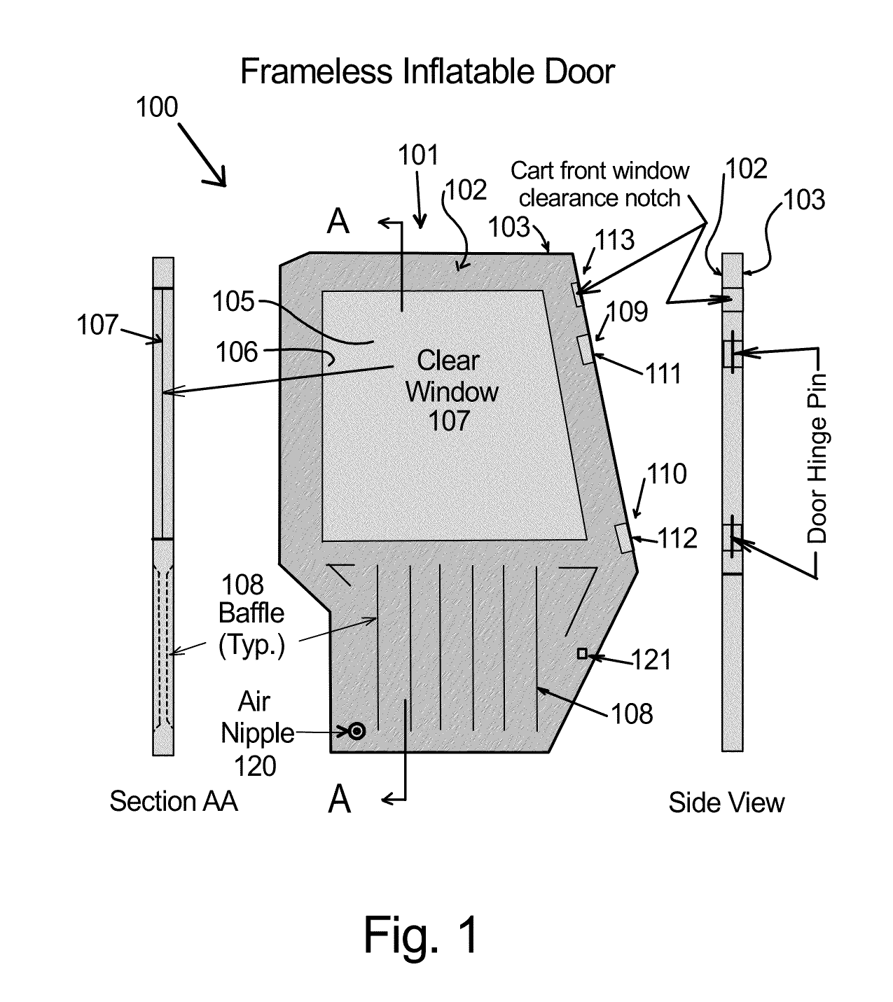

An embodiment of a vehicle door is shown in FIG. 1. Vehicle door 100 is designed as a frameless door. In lieu of a frame, vehicle door 100 is formed by an inflatable bladder 101. Inflatable bladder 101 is formed of a material that is air impermeable so that, as air is inserted into inflatable bladder 101, inflatable bladder 101 will expand into the preformed shape of vehicle door 100. Moreover, inflatable bladder 101 will retain the inserted air until removed or released by the user.

The structure of inflatable bladder 101 is reminiscent of an inflatable raft or air mattress. However, inflatable bladder 101 has a smaller profile, e.g., 0.50″-2.00″, and preferably 0.75″-1.50″, than conventional inflatable rafts or air mattresses. Inflatable bladder 101 can be formed, e.g., by two facing body pieces 102, 103 joined or attached on their peripheries 104 with an adhesive, heat bonding, heat welding, chemical bonding, ultrasonic bonding, supersonic welding, microwave welding or other conventional manners, including sewing and/or stitching, in the known art of inflatable items such as rafts and air mattresses. Further, body pieces 102, 103 can likewise be joined or attached along an opening 105 within body pieces 102, 103 defined by a periphery 106 with an adhesive, heat bonding, heat welding, chemical bonding, ultrasonic bonding, supersonic welding, microwave welding or other conventional manners, including sewing and/or stitching, in the known art of inflatable items such as rafts and air mattresses. Body pieces 102, 103 can be formed from a heavy duty, air impermeable material, such as used with inflatable rafts or air mattresses, e.g., polyurethane (PU), polypropylene (PP), polyvinylchloride (PVC), nylon, mylar, etc. Further, periphery 106 is selected to correspond to the door opening for a vehicle, such as a golf cart, all-terrain vehicle, utility vehicle, cart, etc. and can be selected to correspond to a door opening for specific manufacturer's vehicle, e.g., EZ-GO®, Club Car®, Yamaha®, John Deere®, etc.

A window 107, which can be formed by a single or multiple ply clear plastic sheet, can be inserted within the periphery 106 so that the periphery of window 107 and the peripheries 106 of openings 105 are joined or attached to each other with an adhesive, heat bonding, heat welding, chemical bonding, ultrasonic bonding, supersonic welding, microwave welding or other conventional manners, including sewing and/or stitching, in the known art of inflatable items such as rafts and air mattresses.

Alternatively, window 107 can be attached to body piece 102 or 103 so that at least a portion of window 7 overlaps and is joined or attached to a portion of body piece 102 or 103 bordering opening 105 with an adhesive, heat bonding, heat welding, chemical bonding, ultrasonic bonding, supersonic welding, microwave welding or other conventional manners, including sewing and/or stitching, in the known art of inflatable items such as rafts and air mattresses. By way of example, window 107 can be attached on all edges to be affixed to body piece 102 or 103 or window 107 can be attached on only one edge so that the window can be opened or closed. In this regard, window 107 can be joined or attached to a portion of body pieces 102, 103 bordering the top of opening 105 so that the remaining three edges of window 107 are not fixedly attached to body pieces 102 or 103. The portion of window 107 hanging down can be opened, e.g., by rolling the plastic sheet up toward the upper edge of opening 105. Further, straps having snaps, Velcro, hooks, buckles, clips, etc. can be provided to hold the rolled up window in its opened position. Further, one or more connectors, such as snaps, Velcro, hooks, buckles, clips, etc., can be provided on body 102 or 103 at or near the bottom of opening 105 with a complementary connector attached to the hanging portion of window 107 can be provided to maintain window 107 in a closed position.

To inflate inflatable bladder 101, at least one air valve 120 can be attached to inflatable bladder 101. Air valve 120 can be a PVC valve, Boston valve, pinch valve, double lock valve, Schrader valve, Presta valve, Dunlop valve or other suitable valve connectable to a pump for inflation or valve or nipple for manual inflation. Further, air valve 120 can be used to suction air out of inflatable bladder 101 to enable the inflatable door 100 to be stowed, i.e., rolled or folded and placed into a bag, purse or other storage device. If air valve 120 does not provide for a rapid deflation or for removal of the air via suction, or to provide an additional valve for removing air, inflatable bladder 101 can also include a rapid deflation valve 121 to remove air prior to stowing the inflatable door 100. It is noted that illustrated locations of air valve 120 and of the optional rapid deflation valve 121 are purposes of explanation and should not be construed as limiting in any manner. That is, air valve 120 and optional rapid deflation valve 121 can be located at any location on bladder 101.

To assist inflatable bladder 101 in maintaining a desired shape, baffles 108 can be formed in body pieces 102, 103. In particular, baffles 108 are provided below opening 105, but it is understood that baffles can also be provide elsewhere in body pieces 102, 103 where desired. Further, ribs formed from a flexible yet rigid material can be arranged within inflatable bladder 101 as part of, in addition to or as alternative to baffle 108 to limit the volume for air within inflatable bladder 101. Moreover, these ribs can be connected or bonded to inside surfaces, i.e., the facing surfaces, of body pieces 102, 103. These ribs can be made of foamed rubber or plastic or other material and are preferably oriented vertically and generally parallel to each other.

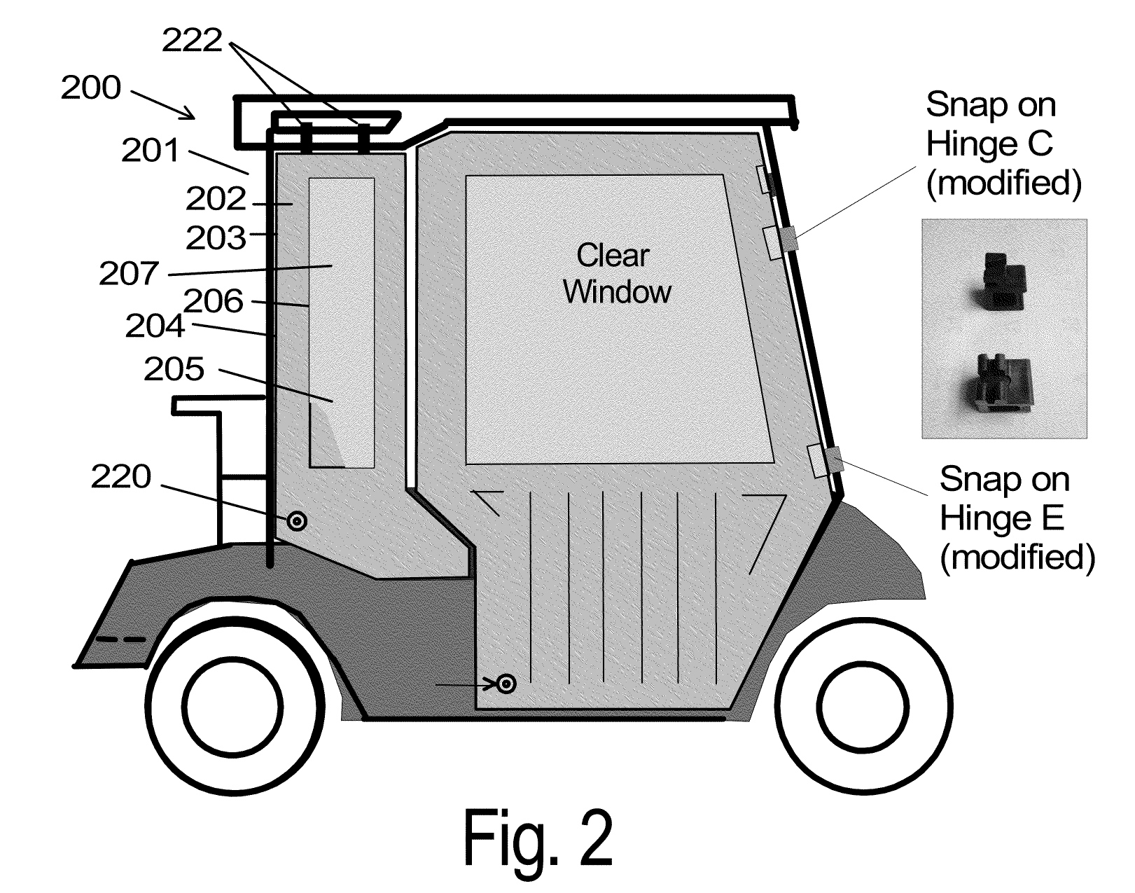

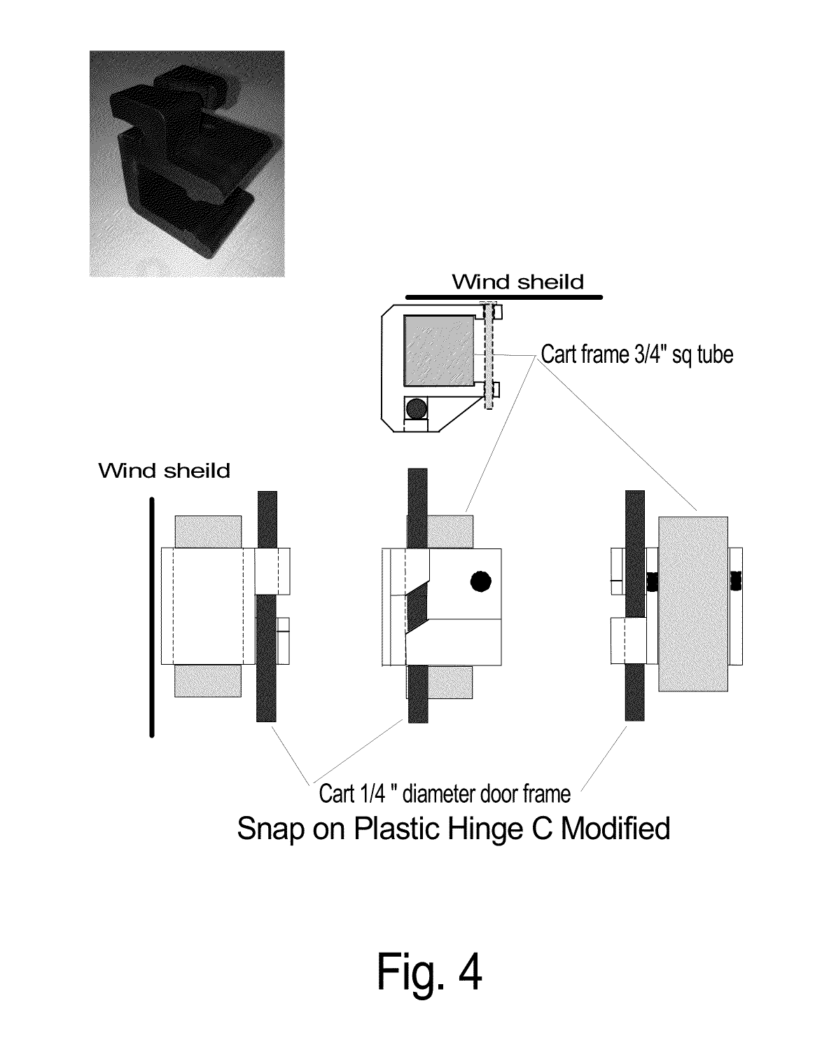

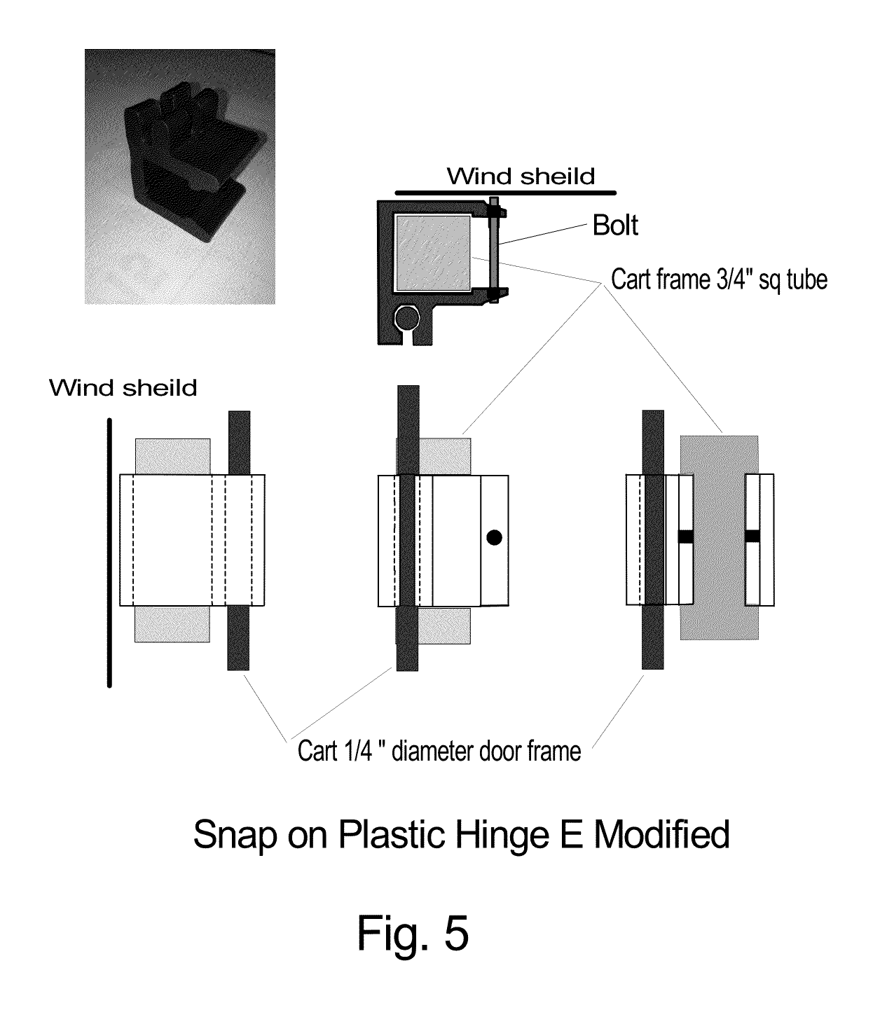

Further, a front edge of body pieces 102, 103 can be formed as a bearing edge with notches 109, 110. Within notches 109, 110, rods or pins 111, 112 can be inserted for connecting inflatable door 100 to the vehicle. Rods or pins 111, 112 can be, and preferably are, structured to correspond to pins 33, 34 discussed in FIG. 4 of Applicant's related U.S. application Ser. No. 14/357,128, the disclosure of which is expressly incorporated by reference in its entirety, in order be received within a hinge body attachable to the vehicle, as shown, e.g., FIGS. 9-11, 16A, 16B and 24 of Applicant's related U.S. application Ser. No. 14/357,128. Moreover, FIGS. 4 and 5 show further embodiments of hinge bodies that are removably connectable to the vehicle frame in order to receive pins 111, 112. Further, the hinges connected to the frame to receive pins 111, 112 can be the same type of hinge or various combinations of hinges can be used, e.g., as shown in FIG. 2. A recess or pouch can be formed in the upper and lower edges of notches 109, 110 to receive and hold the ends of rods or pins 111, 112. Further, preformed pieces including pin 111 or 112, e.g., generally similar in shape or form to the bolt on frame hinge shown in FIG. 23 of Applicant's related U.S. application Ser. No. 14/357,128, can be attached to one of body pieces 102 or 103 with an adhesive, heat bonding, heat welding, chemical bonding, ultrasonic bonding, supersonic welding, microwave welding or other conventional manners, including sewing and/or stitching, in the known art of inflatable items such as rafts and air mattresses. Moreover, notch 113 can also be formed in body pieces 102, 103, as described above with reference to notch G3 shown in FIGS. 14 and 15 of Applicant's related U.S. application Ser. No. 14/357,128.

In a further alternative, one or more Velcro straps or extensions of body panels 102, 103 can extend from the bearing edge with Velcro edges to surround the vehicle frame to act as the hinge. It may be advantageous to include connect an additional piece to the frame to support a lower edge of at least an uppermost of the straps or edges. Further, the lower edge of the strap or extensions of the uppermost of the straps or edges can be supported by a rubber stopper or bumper connected to the frame to act as a bumper and clamp to retain the windshield of the vehicle in an upright position, see FIG. 20 of Applicant's related U.S. application Ser. No. 14/357,128.

Inflatable door 100 can be used in conjunction with side panels 2 (see FIGS. 1 and 18 of Applicant's related U.S. application Ser. No. 14/357,128). Moreover, in accordance with embodiment, these side panels can likewise be frameless inflatable panels 200 as shown in FIG. 2. In this regard, side panel 200 can be formed in a manner similar to inflatable door 100, i.e., side panel 200 can be formed by an inflatable side panel bladder 201 made of an air impermeable material that will expand into a preformed shape of side panel 200 as air is inserted. Moreover, inflatable bladder 101 will retain the inserted air until removed or released by the user.

As with inflatable bladder 101, inflatable side panel bladder 201 is reminiscent of an inflatable raft or air mattress, albeit preferably with a smaller profile, e.g., 0.50″-2.00″, and preferably 0.75″-1.50″, than conventional inflatable rafts or air mattresses. Inflatable side panel bladder 201 can be formed, e.g., by two facing side panel body pieces 202, 203 joined or attached on their peripheries 204 with an adhesive, heat bonding, heat welding, chemical bonding, ultrasonic bonding, supersonic welding, microwave welding or other conventional manners, including sewing and/or stitching, in the known of inflatable items such as rafts and air mattresses. Further, side panel body pieces 202, 203 can likewise be joined or attached along an opening 205 within side panel body pieces 202, 203 defined by a periphery 206 with an adhesive, heat bonding, heat welding, chemical bonding, ultrasonic bonding, supersonic welding, microwave welding or other conventional manners, including sewing and/or stitching, in the known art of inflatable items such as rafts and air mattresses. Body pieces 202, 203 can be formed from a heavy duty, air impermeable material, such as used with inflatable rafts or air mattresses, e.g., polyurethane (PU), polypropylene (PP), polyvinylchloride (PVC), nylon, mylar, etc. Further, periphery 206 is selected to correspond to the side panel opening or the opening not otherwise covered by inflatable door 101 in the closed position for the vehicle, such as a golf cart, all-terrain vehicle, utility vehicle, cart, etc. and can be selected to correspond to a door opening for specific manufacturer's vehicle, e.g., EZ-GO®, Club Car®, Yamaha®, John Deere®, etc.

A window 207, which can be formed by a single or multiple ply clear plastic sheet, can be inserted within the periphery 206 so that the periphery of window 207 and the peripheries 206 of openings 205 are joined or attached to each other with an adhesive, heat bonding, heat welding, chemical bonding, ultrasonic bonding, supersonic welding, microwave welding or other conventional manners, including sewing and/or stitching, in the known art of inflatable items such as rafts and air mattresses.

Alternatively, window 207 can be attached to side panel body piece 202 or 203 so that at least a portion of window 207 overlaps and is joined or attached to a portion of side panel body piece 202 or 203 bordering opening 205 with an adhesive, heat bonding, heat welding, chemical bonding, ultrasonic bonding, supersonic welding, microwave welding or other conventional manners, including sewing and/or stitching, in the known art of inflatable items such as rafts and air mattresses. By way of example, window 207 can be attached on all edges to be affixed to side panel body piece 202 or 203 or window 207 can be attached on only one edge so that the window can be opened or closed. In this regard, window 207 can be joined or attached to a portion of side panel body pieces 202, 203 bordering the top of opening 205 so that the remaining three edges of window 207 are not fixedly attached to side panel body pieces 202 or 203. The portion of window 207 hanging down can be opened, e.g., by rolling the plastic sheet up toward the upper edge of opening 205. Further, straps having snaps, Velcro, hooks, buckles, clips, etc. can be provided to hold the rolled up window in its opened position. Further, one or more connectors, such as snaps, Velcro, hooks, buckles, clips, etc., can be provided on body 202 or 203 at or near the bottom of opening 205 with a complementary connector attached to the hanging portion of window 207 can be provided to maintain window 207 in a closed position.

To inflate inflatable side panel bladder 201, at least one air valve 220 can be attached to inflatable side panel bladder 201. Air valve 220 can be a PVC valve, Boston valve, pinch valve, double lock valve, Schrader valve, Presta valve, Dunlop valve or other suitable valve connectable to a pump for inflation or a valve or nipple for manual inflation. Further, air valve 220 can be used to suction air out of inflatable side panel bladder 201 to enable the inflatable door 200 to be stowed, i.e., rolled or folded and placed into a bag, purse or other storage device. If air valve 220 does not provide for a rapid deflation or for removal of the air via suction, or to provide an additional valve for removing air, inflatable side panel bladder 201 can also include a rapid deflation valve (not shown) to remove air prior to stowing the inflatable door 200. It is noted that illustrated locations of air valve 220 and of the optional rapid deflation valve are purposes of explanation and should not be construed as limiting in any manner. That is, air valve 220 and optional rapid deflation valve can be located at any location on bladder 201.

To assist inflatable side panel bladder 201 in maintaining a desired shape, baffles (not shown) can be formed in side panel body pieces 202, 203. In particular, baffles can be provided below opening 205, but it is understood that baffles can also be provide elsewhere in side panel body pieces 202, 203 where desired. Further, ribs formed from a flexible yet rigid material can be arranged within inflatable side panel bladder 201 as part of, in addition to or as alternative to baffles to limit the volume for air within inflatable side panel bladder 201. Moreover, these ribs can be connected or bonded to inside surfaces, i.e., the facing surfaces, of side panel body pieces 202, 203. These ribs can be made of foamed rubber or plastic or other material and are preferably oriented vertically and generally parallel to each other.

Further, a top edge of side panel body pieces 202, 203 can be formed with straps 222 to connect side panels 200 to the vehicle roof, as shown in FIG. 2. Straps 222 can be formed with snaps, Velcro, hooks, buckles, clips, etc. so that straps 222 can loop around or over an opening or handle formed in the roof of the vehicle. One end of straps 222 can be attached at the periphery 204, e.g., between side panel body pieces 202, 203 with an adhesive, heat bonding, heat welding, chemical bonding, ultrasonic bonding, supersonic welding, microwave welding or other conventional manners, including sewing and/or stitching, in the known art of inflatable items such as rafts and air mattresses, or near the periphery 204 by connection to one or both of side panel body pieces 202 or 203 with an adhesive, heat bonding, heat welding, chemical bonding, ultrasonic bonding, supersonic welding, microwave welding or other conventional manners, including sewing and/or stitching, in the known art of inflatable items such as rafts and air mattresses. Further, body panels 202, 203 can also be formed with slot or openings 223 near the top of inflatable side panel bladder 201 through which straps 222 can be inserted and then looped through or around the opening or handle formed in the roof of the vehicle. The openings are closed with an adhesive, heat bonding, heat welding, chemical bonding, ultrasonic bonding, supersonic welding, microwave welding or other conventional manners, including sewing and/or stitching, in the known art of inflatable items such as rafts and air mattresses so that inflatable side panel bladder 201 remains air-tight. Similar straps can be located at or near the bottom of body panels 202, 203 to connect to a seat handle or part of the vehicle and/or the vehicle frame.

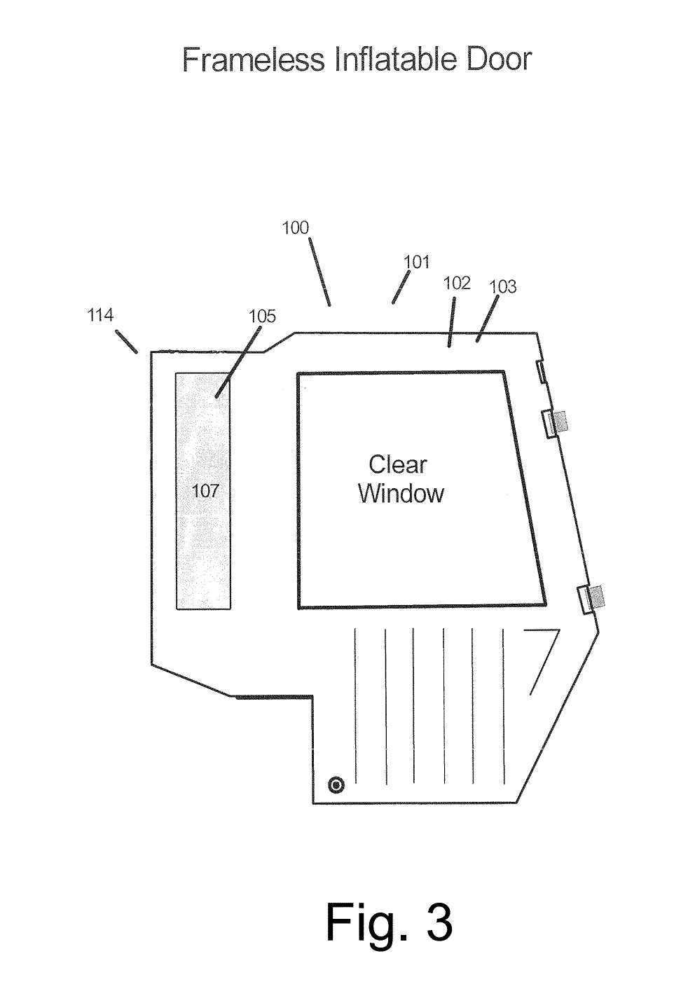

Alternatively, as shown in FIG. 3, inflatable door 100′ can be formed by inflatable bladder 101′ that includes body pieces 102′, 103′, which are structurally similar to body pieces 102, 103, except body pieces 102′, 103′ additionally incorporate an added portion 114 to cover the side panel area of the vehicle. In this manner, the need for side panels 2 can be avoided, thereby reducing the number of elements for use and storage. Moreover, a window 107′ can be inserted into an opening 105′ formed in the added portion. It is understood that body pieces 102′, 103′ can be joined or attached to each other in manner discussed above, and that window 107′ can be joined or attached to bodies 102′, 103′ in the manner discussed above.

Additionally, a handle or strap can be attached to at least one of body pieces 102, 103 to facilitate opening inflatable door 100 from the outside of the vehicle and/or to secure inflatable door in a closed position.

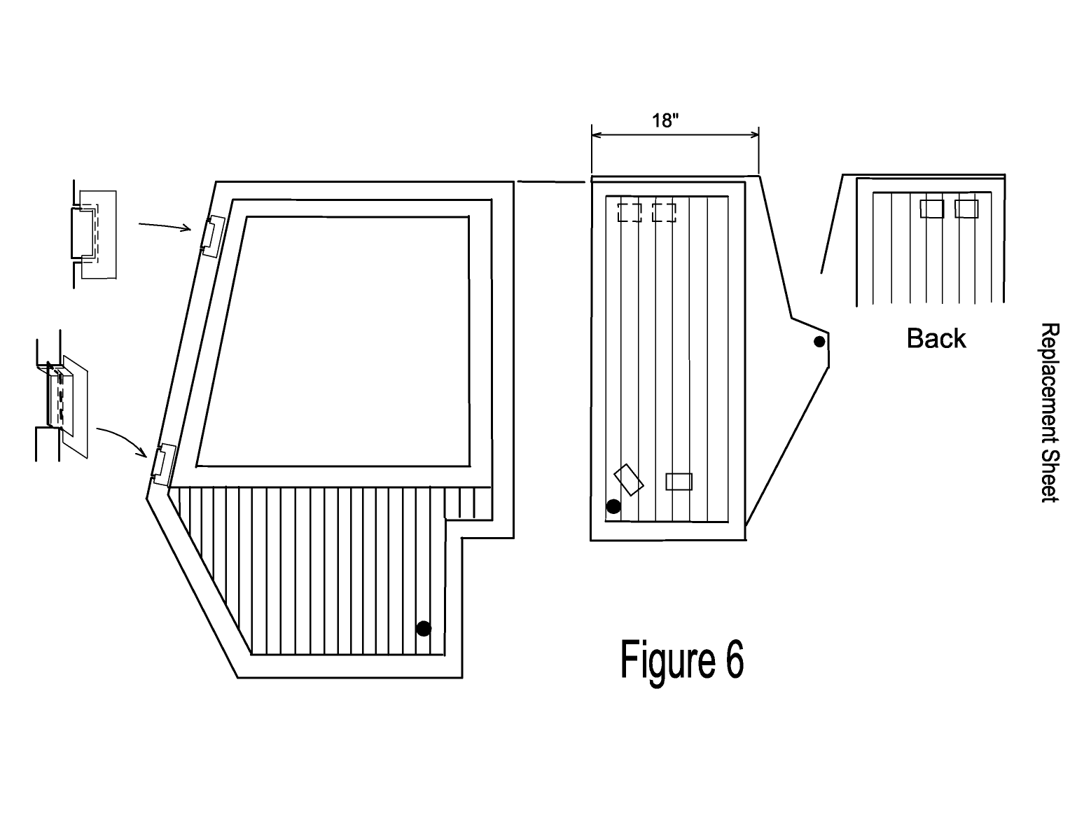

In a further alternative embodiment for rods or pins 111, 112, the pins or rods can be formed by a polygonal or oval loop, as shown in FIG. 6. In such an embodiment, notches 109, 110 can be formed in the bearing edge of the vehicle door and a retaining tape or flap can be arranged within the recessed portion to receive and retain a part of the loop. It is also understood that the polygonal or oval loops can be retained in the notches in other manners that would be apparent to those ordinarily skilled in the art including, but not limited to, molding, ultrasonic welding, adhesives, etc. As shown in FIG. 6, a free portion of the loop, which is opposite the part held by the retaining tape or flap, forms the rod or pin 111, 112 that is aligned with the bearing edge of vehicle door to be received in the hinge. FIG. 6 also shows an alternative embodiment of the side panel, in which the side panel is made entirely of clear plastic. The side panel in FIG. 6 also shows exemplary placement of Velcro pieces for connecting the side panel to the top of the vehicle and to the seat or frame of the vehicle.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. An inflatable door for a vehicle, comprising:
a frameless bladder;
at least one pin coupled to the frameless bladder; and
at least one connection element coupleable to a frame of the vehicle to receive the at least one pin.

2. The inflatable door in accordance with claim 1, further comprising a plastic window.

3. The inflatable door in accordance with claim 2, wherein the plastic window is one of removeable and openable.

4. The inflatable door in accordance with claim 1, wherein the frameless bladder comprises two body pieces.

5. The inflatable door in accordance with claim 4, wherein the frameless bladder further comprises at least one of baffles and ribs.

6. The inflatable door in accordance with claim 1, wherein the at least one pin is connectable to the at least one connection element to form a hinge.

7. The inflatable door in accordance with claim 6, wherein the at least one connection element comprises a channel structured and arranged to receive and retain the at least one pin.

8. The inflatable door in accordance with claim 6, wherein the frameless bladder has a bearing edge and the at least one pin is arranged along and parallel to the bearing edge.

9. The inflatable door in accordance with claim 8, wherein the bearing edge includes one of a retaining tape or flap and the at least one pin comprises one of a polygonal and an oval loop arranged so that the one of the retaining tape or flap holds and retains the loop along and parallel to the bearing edge.

10. The inflatable door in accordance with claim 1, further comprising a strap to hold the door in a closed position.

11. The inflatable door in accordance with claim 1, further comprising a nipple for inflating the frameless bladder.

12. The inflatable door in accordance with claim 1, further comprising a quick release valve for deflating the frameless bladder.

13. An inflatable door kit for a vehicle, comprising:
a frameless bladder;
at least one pin coupled to the frameless bladder; and
at least one connection element removably attachable to a frame of the vehicle to receive the at least one pin.

14. The inflatable door kit in accordance with claim 13, further comprising a side panel removably attachable to the frame of the vehicle adjacent the frameless bladder.

15. The inflatable door kit in accordance with claim 14, wherein the frameless bladder and the side panel include windows.

16. The inflatable door kit in accordance with claim 15, wherein the frameless bladder and the side panel are inflatable.

17. The inflatable door kit in accordance with claim 16, wherein the at least one connection element is connected to the frame of the vehicle via a clamping coupling.

18. The inflatable door kit in accordance with claim 15, wherein the at least one bladder comprises at least one of ribs and baffles arranged at least below the window.

19. The inflatable door kit in accordance with claim 14, wherein the frameless bladder has a bearing edge and the at least one pin is arranged along and parallel to the bearing edge, and the side panel has at least two loops located at a top edge that are structured and arranged for connection to the vehicle.

20. The inflatable door kit in accordance with claim 13, wherein the frameless bladder comprises two body pieces joined together in an air-tight manner.
